(19) United States
(12) Patent Application Publication
(10) Pub. No.: US 2026/0140276 A1
(43) Pub. Date: May 21, 2026

(54) METHOD FOR IDENTIFYING AND MONITORING WATER-CONDUCTING PATH OF WATER INRUSH SOURCE BASED ON SIMILARITY SIMULATION TEST

(71) Applicant: Shandong University of Science and Technology, Qingdao City (CN)

(72) Inventors: Wenbin SUN, Qingdao City (CN); Hui YANG, Qingdao City (CN); Xiaobo ZHANG, Qingdao City (CN); Jinhai ZHAO, Qingdao City (CN); Yixin CHU, Qingdao City (CN); Lijuan LIANG, Qingdao City (CN); Mingkang DING, Qingdao City (CN); Yandong XUE, Qingdao City (CN)

(73) Assignee: Shandong University of Science and Technology, Qingdao City (CN)

(21) Appl. No.: 19/390,184

(22) Filed: Nov. 14, 2025

(30) Foreign Application Priority Data
Nov. 18, 2024 (CN) 202411647361.5

(51) Int. Cl. G01V 8/00; G06V 10/143; G06V 10/28; G06V 10/30; G06V 10/74; G06V 10/75; G06V 20/52; H04N 23/23

(52) U.S. Cl. CPC G01V 8/005; G06V 10/143; G06V 10/28; G06V 10/30; G06V 10/751; G06V 10/761; G06V 20/52; H04N 23/23

(57) ABSTRACT

Provided is a method for identifying and monitoring a water-conducting path of a water inrush source based on a similarity simulation test. The method includes: collecting mining area data, determining lithology and a laying thickness of each rock stratum in a mining area, and performing similar material proportioning for the determined lithology of each rock stratum; and using an exothermic material as a layered material for the similarity simulation test. According to the method for identifying and monitoring a water-conducting path of a water inrush source based on a similarity simulation test, the exothermic material is used in the similarity simulation test, to enhance a temperature response capability of various rock strata in a test environment. Subtle temperature changes in the rock strata can be reflected more accurately in a water inrush process, and therefore, monitoring precision is improved.

### CROSS REFERENCE TO RELATED APPLICATION

This patent application claims the benefit and priority of Chinese Patent Application No. 202411647361.5, filed with the China National Intellectual Property Administration on Nov. 18, 2024, the disclosure of which is incorporated by reference herein in its entirety as part of the present application.

### TECHNICAL FIELD

The present disclosure relates to the field of mine water hazard prevention and control technologies, and specifically relates to a method for identifying and monitoring a water-conducting path of a water inrush source based on a similarity simulation test.

### BACKGROUND

With an increasing depth of coal mining, underground confined water activities have become more frequent, leading to a gradual rise in the risk of a water inrush from the floor during mining. The water inrush not only causes direct losses including mine flooding, equipment damage, and the like, but also endangers the lives of underground workers. Therefore, how to quickly and accurately identify and monitor a water inrush path during mining has become a critical technology for coal mine safety protection.

An existing monitoring technology for a water inrush path mainly relies on methods including water pressure observation, borehole detection, and the like. These methods have a plurality of limitations, including an inability to achieve real-time monitoring, a long monitoring cycle, difficulty in capturing a dynamically changing water inrush path, and the like. In addition, a traditional monitoring method has limited accuracy in predicting a water inrush path and has difficulty in reflecting subtle changes in the water inrush process in a timely manner.

An infrared thermal imaging technology has advantages of non-contact, long-range and real-time monitoring, and gradually becomes a novel method for monitoring a water inrush in mines. Through infrared imaging, a temperature distribution in a mining area can be obtained in real time, and a water inrush path can be identified by analyzing a temperature anomaly zone.

However, an existing infrared thermal-imaging monitoring method still has some limitations. For example, issues such as a limited image resolution, noise interference, and uneven illumination affecting image clarity make it difficult to identify a water inrush path in a thermal image. Therefore, improving the quality and resolution of an infrared thermal image, reducing noise interference, and further enhancing visualization of the water inrush path are of significant research importance in the field of mine water hazard prevention and control.

### SUMMARY

To resolve the aforementioned problems in an existing water inrush path monitoring technology, including an inability to achieve real-time monitoring, a long monitoring cycle, difficulty in capturing a dynamic change in a water inrush path, and difficulty in reflecting a subtle change in a water inrush process as well as problems in a current infrared thermal-imaging monitoring method, including great difficulty in identifying a water inrush path in a thermal image, and the like due to a limited image resolution, noise interference, and uneven illumination, the present disclosure implements the following technical solution: A method for identifying and monitoring a water-conducting path of a water inrush source based on a similarity simulation test includes:
S1, collecting mining area data, determining lithology and a laying thickness of each rock stratum in a mining area, and performing similar material proportioning for the determined lithology of each rock stratum;
S2, using an exothermic material as a layered material for the similarity simulation test; S3, using a similarity simulation test system for a water inrush from a coal seam floor during mining to lay a test material and construct a similarity simulation test environment;
S4, deploying an infrared thermal imager to measure infrared heat of the similarity simulation test environment;
S5, during a mining process, using the infrared thermal imager to obtain a real-time thermal image and a real-time temperature value, thereby preliminarily identifying and monitoring a water inrush path;
S6, after the mining process ends, exporting a measurement result, and obtaining and analyzing measurement data to obtain the water inrush path; and
S7, performing comparative analysis on the real-time thermal image and a path image obtained through algorithmic processing to obtain a detailed and accurate test result.

Further, the step S4 of deploying an infrared thermal imager to measure infrared heat of the similarity simulation test environment specifically includes:
S4.1, deploying the infrared thermal imager at a location covering a mining-affected zone, a fault zone, and a potential water inrush path; and
S4.2, setting a measurement range and a resolution of the infrared thermal imager to ensure that the infrared thermal imager is able to monitor a local temperature change during the mining process.

Further, the step S5 specifically includes:
S5.1, during the mining process, using the infrared thermal imager to monitor the similarity simulation test in real time and obtain the real-time thermal image and the real-time temperature value through a conversion function of the infrared thermal imager; and
S5.2, performing real-time analysis on the real-time thermal image to implement visual monitoring of the water inrush path formed during an upward conduction process of high confined water.

Further, the step S5.1 specifically includes:
S5.11, continuously scanning, by the infrared thermal imager, a simulated mining area and collecting temperature data of the simulated mining area in real time; and
S5.12, detecting, by the infrared thermal imager, infrared energy in a non-contact manner, converting the infrared energy into an electrical signal, and generating the visual thermal image and the temperature value on a display.

Further, the step S5.2 specifically includes:
S5.21, in the thermal image, causing high-pressure water to flow and undergo a chemical reaction with a component in the exothermic material to release thermal energy and result in a local temperature anomaly, identifying an area with a rapid temperature increase or decrease, and analyzing a movement trajectory of water flow, to make the water inrush path gradually appear in the thermal image; and
S5.22, generating a continuous thermal image sequence at a set frequency, performing real-time monitoring, comparing thermal images at different moments, and analyzing a dynamic temperature change process to show an extension and a trend of the water inrush path as displacement and diffusion of a temperature anomaly zone in the thermal image.

Further, the step S6 specifically includes:
S6.1, after the mining process ends, exporting the measurement result from a storage system of the infrared thermal imager to obtain the measurement data; and
S6.2, using a total variation-Retinex (TV-Retinex) algorithm to process the exported image data and obtain the water inrush path.

Further, the step S6.2 of using a TV-Retinex algorithm to process the exported image data specifically includes:
S6.21, preprocessing original image data:
performing noise reduction, where a Gaussian filtering or median filtering technology is used to remove noise and eliminate a random temperature change that may affect path identification; and performing contrast enhancement, where image contrast is adjusted through histogram equalization to enhance overall visibility of the thermal image, to make the water inrush path more visible in the thermal image; and
S6.22, combining the TV-Retinex algorithm with a Retinex theory and a total variation regularization technology to enhance a preprocessed image:
using a Retinex theory model to perform illumination correction and color constancy processing on the thermal image; and
processing the thermal image by using a total variation regularization method to remove noise and an artifact introduced during processing.

Further, the step S7 specifically includes:
comparing thermal images and processed images at different moments, and analyzing dynamic changes in speed, direction, and range of extension of the water inrush path during the upward conduction process of the high confined water.

Compared with the conventional technology, the present disclosure has the following beneficial effects:
1. According to the method for identifying and monitoring a water-conducting path of a water inrush source based on a similarity simulation test, the exothermic material is used in the similarity simulation test, to enhance a temperature response capability of various rock strata in a test environment. Subtle temperature changes in the rock strata can be reflected more accurately in a water inrush process, and therefore, monitoring precision is improved. In the water inrush monitoring process, the thermal image is obtained by the infrared thermal imager in real time, and a real-time temperature distribution in the mining process, especially a temperature change in a flowing area of high confined water can be shown to reflect a dynamic condition of the water inrush, including a temperature anomaly zone and a preliminary outline of the water inrush path.
2. According to the method for identifying and monitoring a water-conducting path of a water inrush source based on a similarity simulation test, the TV-Retinex algorithm is used to process the exported thermal image data to generate a clear image of the water inrush path. A trend of the water inrush path and a temperature change trend can be accurately displayed though the algorithmically processed images that are subjected to contrast enhancement, noise reduction, and edge sharpening. Noise and uneven illumination are eliminated for the processed images, and critical details of the water inrush path are further highlighted.

### BRIEF DESCRIPTION OF THE DRAWINGS

FIG. 1 is a flowchart of a method for identifying and monitoring a water-conducting path of a water inrush source;

FIG. 2 is a columnar diagram of a coal seam and surrounding rock distribution in a similarity simulation test according to an embodiment of the present disclosure; and

FIG. 3 is a flowchart of processing image data by using a total variation-Retinex (TV-Retinex) algorithm according to the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other examples derived by those of ordinary skill in the art based on the examples of the present disclosure without creative efforts should fall within the protection scope of the present disclosure.

The following provides an embodiment of a method for identifying and monitoring a water-conducting path of a water inrush source based on a similarity simulation test.

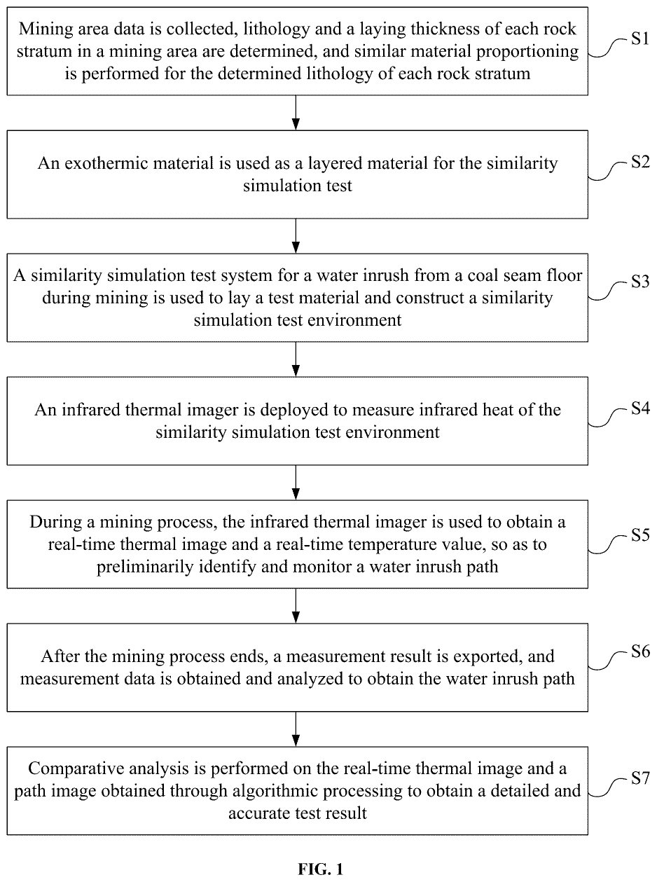

Refer to FIG. 1 to FIG. 3. A method for identifying and monitoring a water-conducting path of a water inrush source based on a similarity simulation test includes the following steps.

In step S1, mining area data is collected, lithology and a laying thickness of each rock stratum in a mining area are determined, and similar material proportioning is performed for the determined lithology of each rock stratum.

In step S2, an exothermic material is used as a layered material for the similarity simulation test.

In step S3, a similarity simulation test system for a water inrush from a coal seam floor during mining is used to lay a test material and construct a similarity simulation test environment.

In step S4, an infrared thermal imager is deployed to measure infrared heat of the similarity simulation test environment.

In step S4.1, the infrared thermal imager is deployed at a location covering a mining-affected zone, a fault zone, and a potential water inrush path.

In step S4.2, a measurement range and a resolution of the infrared thermal imager are set to ensure that the infrared thermal imager is able to monitor a local temperature change during the mining process.

In step S5, during a mining process, the infrared thermal imager is used to obtain a real-time thermal image and a real-time temperature value, so as to preliminarily identify and monitor a water inrush path.

In step S5.1, during the mining process, the infrared thermal imager is used to monitor the similarity simulation test in real time and obtain the real-time thermal image and the real-time temperature value through a conversion function of the infrared thermal imager.

In step S5.11, a simulated mining area is continuously scanned by the infrared thermal imager, and temperature data of the simulated mining area is collected in real time.

In step S5.12, infrared energy is detected by the infrared thermal imager in a non-contact manner, the infrared energy is converted into an electrical signal, and the visual thermal image and the temperature value are generated on a display.

In step S5.2, real-time analysis is performed on the thermal image to implement visual monitoring of the water inrush path formed during an upward conduction process of high confined water.

In step S5.21, in the thermal image, high-pressure water flows and undergoes a chemical reaction with a component in the exothermic material to release thermal energy and result in a local temperature anomaly, an area with a rapid temperature increase or decrease is identified, and a movement trajectory of water flow is analyzed, to make the water inrush path gradually appear in the thermal image.

In step S5.22, a continuous thermal image sequence is generated at a set frequency, real-time monitoring is performed, thermal images at different moments are compared, and a dynamic temperature change process is analyzed to show an extension and a trend of the water inrush path as displacement and diffusion of a temperature anomaly zone in the thermal image.

In step S6, after the mining process ends, a measurement result is exported, and measurement data is obtained and analyzed to obtain the water inrush path.

In step S6.1, after the mining process ends, the measurement result is exported from a storage system of the infrared thermal imager to obtain the measurement data.

In step S6.2, a total variation-Retinex (TV-Retinex algorithm) is used to process the exported image data and obtain the water inrush path.

In step S6.21, original image data is preprocessed as follows:

Noise reduction is performed, where a Gaussian filtering or median filtering technology is used to remove noise and eliminate a random temperature change that may affect path identification.

Contrast enhancement is performed, where image contrast is adjusted through histogram equalization to enhance overall visibility of the thermal image, to make the water inrush path more visible in the thermal image.

In step S6.22, the TV-Retinex algorithm is combined with a Retinex theory and a total variation regularization technology to enhance a preprocessed image as follows:

A Retinex theory model is used to perform illumination correction and color constancy processing on the thermal image.

The thermal image is further processed by using a total variation regularization method to remove noise and an artifact introduced during processing.

In step S7, comparative analysis is performed on the real-time thermal image and a path image obtained through algorithmic processing to obtain a detailed and accurate test result.

Thermal images and processed images are compared at different moments, and dynamic changes in speed, direction, and range of extension of the water inrush path are analyzed during the upward conduction process of the high-pressure confined water.

The specific implementation is as follows:

Based on geological survey data of a mining area, a lithology, a thickness, and relevant parameters of each rock stratum in the mining area, particularly characteristics of floor strata, are determined. Suitable similar materials are designed by using these data for proportioning. Similar materials in the test are required to simulate mechanical properties of each rock stratum, and further reflect response characteristics of the rock strata to temperature changes.

In this embodiment, original geological data for the similarity simulation test are obtained by analyzing geological materials from a mine in Huainan. Furthermore, to simulate fault-induced water inrush through the similarity simulation test, the configured rock strata should satisfy a specific geometric similarity ratio.

The geometric similarity means spatial sizes of a model and a prototype are in a specific proportion according to the following formula:

$${C}_{1} = \frac{{x}^{′}}{{x}^{″}} = \frac{{y}^{′}}{{y}^{″}} = \frac{{z}^{′}}{{z}^{″}} = 100$$

C₁ is a geometric similarity ratio.
x′, y′, and z′ are geometric sizes of the prototype in directions x, y, and z, in cm.
x″, y″, and z″ are geometric sizes of the model in directions x, y, and z, in cm.

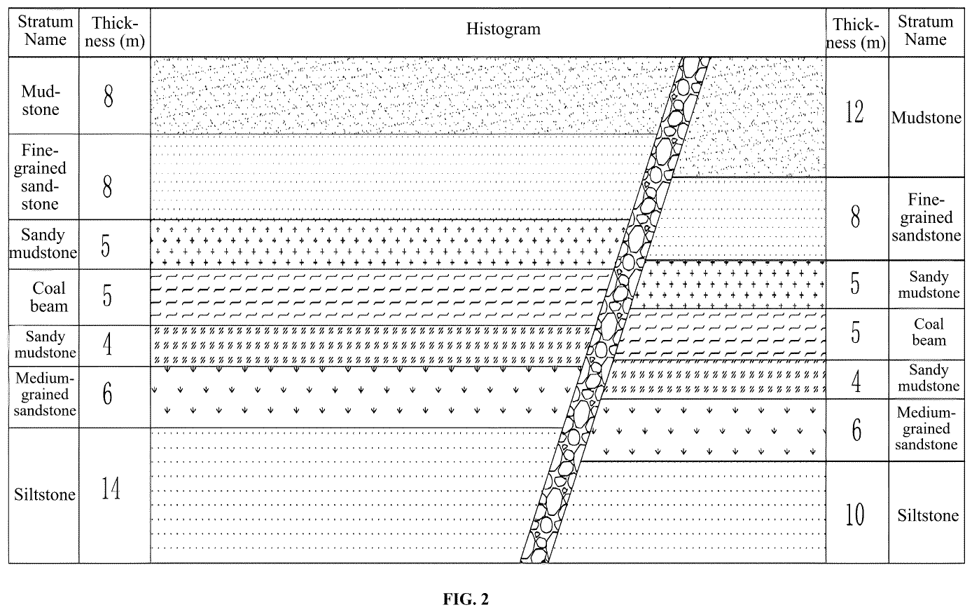

According to an effective size of a test stand used and relative spatial positions of the fault and aquifer under study, a geometric similarity ratio of 1:100 is obtained in combination with the foregoing formula, to determine the model size for the test. As shown in FIG. 2, sizes of rock strata in the similarity simulation test are obtained according to the geometric similarity ratio of 1:100.

During model laying, hydrogeological conditions of the mine are combined with test result requirements. Overlying strata are simulated by using hydrophilic similar materials, as shown in Table 1. Floor strata are simulated by using hydrophobic fluid-solid coupling similar materials, as shown in Table 2.

TABLE 1

| | | Simulation | Similar | Prototype |
|---|---|---|---|---|
| | | material | material | rock |
| Rock | Rock | mass ratio | compressive | compressive |
| stratum | stratum | (Sand:calcium | strength | strength |
| property | name | carbonate:gypsum) | (MPa) | (MPa) |
| Overlying | Mudstone | 8:7:3 | 0.613 | 80.4 |
| strata | Fine- | 6:5:5 | 0.311 | 41.8 |
| | grained | | | |
| | sandstone | | | |
| | Sandy | 8:8:2 | 0.502 | 75.3 |
| | mudstone | | | |

TABLE 2

| | | Simulation material | Similar | Prototype |
|---|---|---|---|---|
| | | mass ratio | material | rock |
| Rock | Rock | (sand:paraffin:hydrau- | compressive | compressive |
| stratum | stratum | lic oil:calcium | strength | strength |
| property | name | carbonate:vaseline) | (MPa) | (MPa) |
| Coal | Coal | 30:1:0.8:1.1 | 0.153 | 15.5 |
| seam | seam | | | |
| Floor | Sandy | 14:1.6:0.7:1.2:0.7 | 0.7 | 75.3 |
| strata | mudstone | | | |
| | Medium- | 18:0.8:0.6:1.2:0.8 | 0.58 | 40 |
| | grained | | | |
| | sandstone | | | |
| | Siltstone | 18:1:0.7:1.2:0.9 | 0.285 | 28.8 |

In this process, an exothermic material is used as a layered material for the similarity simulation test. Heat is released from these materials during a chemical reaction, and a heat flow condition in an actual underground environment is simulated. The exothermic material is introduced into a test system, and generation of thermal anomalies can be accurately simulated during a water inrush test in a mined coal seam floor, to provide reliable temperature change data for subsequent infrared thermal imaging monitoring.

After a similarity simulation test stand is constructed, suitable locations are selected to deploy the infrared thermal imager. The infrared thermal imager should be deployed to cover the entire mining-induced area, the fault, and a potential water inrush path. An appropriate measurement range and an appropriate resolution are set to ensure precise monitoring of a temperature change of the water inrush path. In this embodiment, the resolution of the infrared thermal imager is 640×480 pixels.

During the mining process, a test result area is continuously scanned by the infrared thermal imager in a non-contact manner, temperature data is acquired in real time, and a thermal image is generated. Infrared energy is detected by the infrared thermal imager in a non-contact manner, the infrared energy is converted into an electrical signal, and the visual thermal image and the visual temperature are generated on a display. A temperature distribution status during the mining process is reflected through these images, and initial emergence of the water inrush path can be analyzed by positioning a temperature anomaly zone.

During the mining process, as a floor water inrush occurs accompanied by flow of high confined water, the water has a chemical reaction with the exothermic material while flowing through the exothermic material, releasing heat and causing an abnormal temperature change. The temperature change is monitored by the infrared thermal imager in real time, and formation of the water inrush path can be preliminarily identified.

A continuous thermal image sequence is generated by the infrared thermal imager at a frequency of seconds or minutes. The abnormal temperature changes are shown as a local temperature increase or decrease in the thermal image. These continuous thermal images are analyzed to further analyze a dynamic change process of the water inrush path, including a direction and rate of a water inrush path extension.

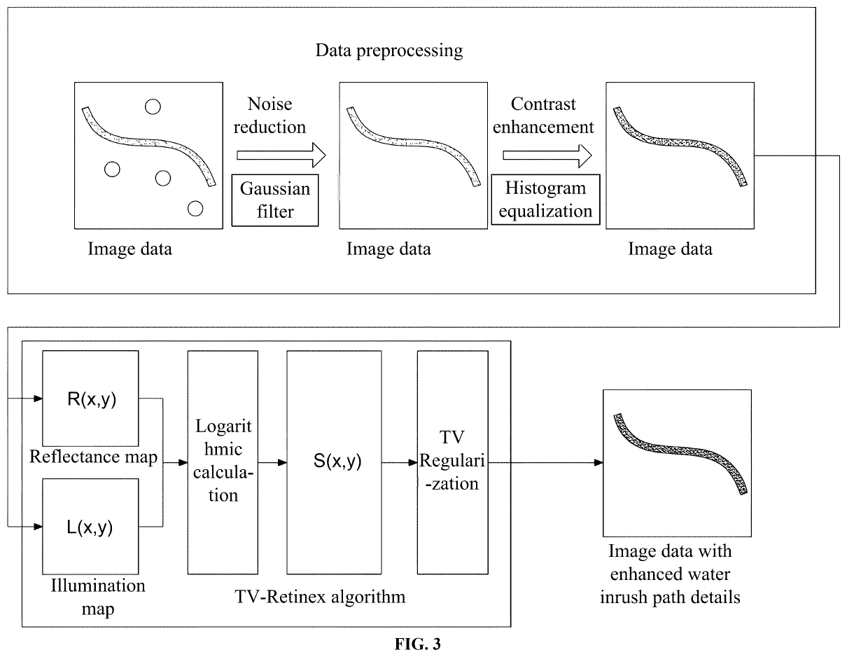

As shown in FIG. 3, this embodiment provides a method for processing exported image data by using the TV-Retinex algorithm. The method mainly includes two parts: data preprocessing and TV-Retinex algorithm processing, where the data preprocessing further includes noise reduction and contrast enhancement.

First, a raw image exported from the infrared thermal imager is preprocessed, including noise reduction and contrast enhancement.

During noise reduction, a Gaussian filter is configured to smooth noise, ensuring more reliable temperature change information in the image.

During contrast enhancement, histogram equalization is applied to adjust a brightness range of the image, making a temperature difference of the water inrush path more distinct.

Then, the preprocessed image is enhanced by using the TV-Retinex algorithm. In this algorithm, a Retinex theory is combined with a total variation (TV) regularization technology, to highlight a local temperature anomaly area in the thermal image and reduce interference from uneven illumination on visualization of the water inrush path.

In the Retinex theory, a Retinex model is configured to perform illumination correction and color constancy processing on the thermal image. An illumination component and a reflectance component in the thermal image are separated by using the Retinex theory, thereby highlighting a subtle temperature change in the water inrush path. The result of illumination correction is that a high-temperature area in the water inrush path is more prominent relative to the surrounding background, thereby facilitating observation and analysis.

According to the Retinex theory, an image can be expressed as a product of a reflectance map and an illumination map.

$$S ( x , y ) = R ( x , y ) \cdot L ( x , y )$$

S(x, y) Represents a pixel value of a point (x, y) in the image.

R(x, y) is the reflectance map, and represents an inherent thermal characteristic of an object surface.

L(x, y) Is the illumination map, and represents effect of illumination on an object.

By using a logarithmic transform, a multiplicative relationship is converted to an additive form:

$$log ( S ( x , y ) ) = log ( R ( x , y ) ) + log ( L ( x , y ) )$$

In this way, the problem is transformed into separation of log (R(x, y)) and log (L(x, y)) from log (S(x, y)).

In the TV regularization, the image is further processed by using a TV regularization method to remove noise and an artifact that are possibly introduced during processing. An edge structure of the image and clear boundaries of the water inrush path can be preserved through TV regularization, to avoid destruction of path details during contrast enhancement.

An expression of the TV regularization is as follows:

$$T V ( S ) = \int \vert ∇ S \vert dxdy$$

∇ S is an image gradient, and S represents an image function value of a point (x, y) in the image.

An objective of the TV regularization is to make the boundaries of the water inrush path clearer by minimizing the image gradient.

During TV-Retinex integrated processing, the TV-Retinex algorithm is combined with advantages of both Retinex and TV regularization.

An objective function of TV-Retinex integrated processing is as follows:

$${min}_{R , L} \{ \int \vert ∇ R \vert dxdy + λ \int {( log ( S ) - log ( L ) - R )}^{2} dxdy \}$$

∇R represents a gradient of the reflectance map, namely, a rate of a temperature change in the image; S represents an image function value of a point (x, y) in the image; R is the reflectance map, representing the inherent thermal characteristics of the object surface; L is the illumination map, representing the effect of illumination on the object; and λ is a weight parameter controlling the balance between the TV regularization term and a data fidelity term.

The TV-Retinex algorithm is used to minimize the objective function to simultaneously suppress noise and enhance edges and details in the reflectance map.

Through the TV-Retinex algorithm, temperature images exported from the infrared thermal imager are significantly improved, especially details of the floor water inrush path are more distinct. A temperature anomaly zone is highlighted, facilitating rapid and accurate identification of a water inrush path in a complex environment and providing strong support for mine water hazard prevention and control.

Thermal images and processed images at different moments are compared, and dynamic changes of the water inrush path, particularly a speed, a direction, and a scope of path extension during an upward conduction process of high confined water are analyzed. A latest state of the water inrush can be reflected through real-time monitoring data, and clearer and more detailed path information is provided by algorithm-processed images.

What is claimed is:

1. A method for identifying and monitoring a water-conducting path of a water inrush source based on a similarity simulation test, comprising:
S1, collecting mining area data, determining lithology and a laying thickness of each rock stratum in a mining area, and performing similar material proportioning for the determined lithology of each rock stratum;
S2, using an exothermic material as a layered material for the similarity simulation test;
S3, using a similarity simulation test system for a water inrush from a coal seam floor during mining to lay a test material and construct a similarity simulation test environment;
S4, deploying an infrared thermal imager to measure infrared heat of the similarity simulation test environment;
S5, during a mining process, using the infrared thermal imager to obtain a real-time thermal image and a real-time temperature value, thereby preliminarily identifying and monitoring a water inrush path;
S6, after the mining process ends, exporting a measurement result, and obtaining and analyzing measurement data to obtain the water inrush path; and
S7, performing comparative analysis on the real-time thermal image and a path image obtained through algorithmic processing to obtain a detailed and accurate test result;
wherein the step S5 comprises:
S5.1, during the mining process, using the infrared thermal imager to monitor the similarity simulation test in real time and obtain the real-time thermal image and the real-time temperature value through a conversion function of the infrared thermal imager; and
S5.2, performing real-time analysis on the thermal image to implement visual monitoring of the water inrush path formed during an upward conduction process of high confined water;
wherein the step S5.1 comprises:
S5.11, continuously scanning, by the infrared thermal imager, a simulated mining area and collecting temperature data of the simulated mining area in real time; and
S5.12, detecting, by the infrared thermal imager, infrared energy in a non-contact manner, converting the infrared energy into an electrical signal, and generating the real-time thermal image and the real-time temperature value on a display;
the step S5.2 comprises:
S5.21, in the thermal image, causing high-pressure water to flow and undergo a chemical reaction with a component in the exothermic material to release thermal energy and result in a local temperature anomaly, identifying an area with a rapid temperature increase or decrease, and analyzing a movement trajectory of water flow, to make the water inrush path gradually appear in the thermal image; and
S5.22, generating a continuous thermal image sequence at a set frequency, performing real-time monitoring, comparing thermal images at different moments, and analyzing a dynamic temperature change process to show an extension and a trend of the water inrush path as displacement and diffusion of a temperature anomaly zone in the thermal image; and
the step S6 comprises:
S6.1, after the mining process ends, exporting the measurement result from a storage system of the infrared thermal imager to obtain the measurement data; and
S6.2, using a total variation-Retinex (TV-Retinex) algorithm to process the exported image data and obtain the water inrush path;
wherein the step S6.2 of using the TV-Retinex algorithm to process the exported image data comprises:
S6.21, preprocessing original image data, comprising:
performing noise reduction, wherein a Gaussian filtering or median filtering technology is used to remove noise and eliminate a random temperature change that affects path identification; and
performing contrast enhancement, wherein image contrast is adjusted through histogram equalization to enhance overall visibility of the thermal image, to make the water inrush path more visible in the thermal image; and
S6.22, combining the TV-Retinex algorithm with a Retinex theory and a total variation regularization technology to enhance a preprocessed image, comprising:
using a Retinex theory model to perform illumination correction and color constancy processing on the thermal image; and
processing the thermal image by using a total variation regularization method to remove noise and an artifact introduced during processing.

2. The method for identifying and monitoring a water-conducting path of a water inrush source based on a similarity simulation test according to claim 1, wherein the step S4 of deploying the infrared thermal imager to measure infrared heat of the similarity simulation test environment comprises:
S4.1, deploying the infrared thermal imager at a location covering a mining-affected zone, a fault zone, and a potential water inrush path; and
S4.2, setting a measurement range and a resolution of the infrared thermal imager to ensure that the infrared thermal imager is able to monitor a local temperature change during the mining process.

3. The method for identifying and monitoring a water-conducting path of a water inrush source based on a similarity simulation test according to claim 1, wherein the step S7 comprises:
comparing thermal images and processed images at different moments, and analyzing dynamic changes in speed, direction, and range of extension of the water inrush path during the upward conduction process of the high confined water confined water.
